(19) United States
(12) Patent Application Publication
(10) Pub. No.: US 2008/0071606 A1
(43) Pub. Date: Mar. 20, 2008

(54) Method and system for email-based "push" lead management tool for customer relationship management

(76) Inventors: Sean Whiteley, Los Angeles, CA (US); Kenneth Curtis Brotherton, Burbank, CA (US); Jiayu Ye, Los Angeles, CA (US)

Correspondence Address: Cislo & Thomas LLP, 1333 2nd Street, Suite #500, Santa Monica, CA, 90401-4110, US

(21) Appl. No.: 11/899,380

(22) Filed: Sep. 4, 2007

Related U.S. Application Data
(60) Provisional application No. 60/842,707, filed on Sep. 5, 2006.

(51) Int. Cl. G06Q 10/00; G06F 17/30; G06Q 30/00; G06F 17/40

(52) U.S. Cl. 705/10

(57) ABSTRACT

A customer relationship management/CRM system enables a user thereof to focus more upon customers and clients instead of keeping track of such customers and clients. Upon initiating contact with a potential new customer or client, the new lead can be entered into the system and the user queried with respect to anticipated future activity. The present system then periodically queries the user with regards to the development and activities with regards to the lead. In doing so, the user is guided to pursue development of the potential customer and creates an ongoing written or recorded history by which retrospective evaluation can occur. The present invention can generally be applied in any industry that uses contact management systems.

### CROSS-REFERENCES TO RELATED APPLICATIONS

Applicant(s) and/or Inventor(s) hereby rescind any disclaimer and/or any arguments made in any prior related application. Such disclaimer(s) and/or argument(s) as well as any prior art relevant to such disclaimer(s) and/or argument(s) may need to be revisited by the Examiner.

This patent application is related to and claims priority from U.S. Provisional Patent Application Ser. No. 60/842,707 filed Sep. 5, 2006 entitled Method and System for Email-Based “Push” Lead Management Tool for Customer Relationship Management which application is incorporated herein by this reference thereto.

### COPYRIGHT AUTHORIZATION

Portions of the disclosure of this patent document may contain material which is subject to copyright and/or mask work protection. The copyright and/or mask work owner has no objection to the facsimile reproduction by anyone of the patent document or the patent disclosure, as it appears in the Patent and Trademark Office patent file or records, but otherwise reserves all copyright and/or mask work rights whatsoever. 37 C.F.R. § 1.71(d).

### BACKGROUND OF THE INVENTION

1. Field of the Invention

The present invention relates generally to the field of customer relationship management software. More specifically, the present invention relates to a system and process for managing communication and tracking results of potential sources of business, or leads, in an efficient and effective manner. The present invention uses backend logic on a server to communicate with the user via electronic mail or other spontaneous message system. The present invention can be applied in any industry that uses contact management systems.

2. Description of the Related Art

The potential customer, or “lead,” is an indispensable source of revenue and future growth for any business entity. Accordingly, great importance is placed in developing a business strategy that has the ability to generate and establish strong business relationships with potential customers. The responsibility of customer relationship management can be assigned to designated marketing groups within large companies or, alternatively, can be an additional responsibility of small business owners. Traditional customer relationship managers include realtors, mortgage brokers, stock brokers, agents, sales professionals, stock brokers, bankers, financial advisors, real estate agents, travel agents, insurance agents, lawyers and other professionals. Nevertheless, the goal of each individual customer relationship manager, is the same—to manage existing customer relationships and develop additional business prospects.

A key feature of successful customer relationship management practice is responsive and effective communication. A relationship manager must timely communicate with potential customers to ensure that the customer is aware of the business' availability to address the customer's needs. More often than not, due to expanding commitments and responsibilities, businesses fail to follow-up with potential customers resulting in a loss of business opportunity. For example, in the real estate business, real estate agents acting as customer managers report closing a deal for 1 of every 20 connections made. Furthermore, on average it takes approximately 6-8 months for an agent to receive a commission from the time the agent first makes contact with a client. Many real estate agents fail specifically because they are not able to keep track of and follow-up with potential clients.

An additional key feature of successful customer relationship management practice is to effectively monitor the efforts undertaken by the relationship manager to develop new business. A business entity must be able to accurately account for the status of each potential business contact in order to determine what actions were successful in generating new business. In this way, the relationship manager could determine his return on investment of time, money, and effort spent on each new potential customer. However, despite the value associated with being able to effectively and efficiently follow-up on customer leads and determine the return-on-investment of the time, money, and effort, spent on customer leads, relationship managers lack adequate tools to address these needs.

Although software tools have been developed to manage and build customer relationships, these tools do not meet the expanding needs of many businesses. For example, currently available customer relationship management tools require complex graphical user interfaces that burden individual systems, create additional work for the user, and result in a waste of time and efficiency. Alternatively, currently available tools act as databanks, simply storing data generated by the user. As yet a further example, currently available tools require the user to download large software application bundles onto the user's personal computer, PDA, or remote device, clogging precious memory to run additional applications. As a result, Currently available tools do not adequately address the needs of successful customer relationship managers.

Therefore, it would be highly desirable to a relationship manager to have available a convenient and user-friendly customer management tool that would allow the manager to timely follow-up with potential customers and determine his return-on-investment of time, money, and effort spent on each potential customer.

### SUMMARY OF THE INVENTION

In view of the foregoing disadvantages inherent in the known types of customer relationship management systems now present in the prior art, the present invention provides a new customer relationship management tool that is widely available and easy to use wherein the same can be used to manage new and existing customers to the benefit of the user.

The general purpose of the present invention, which will be described subsequently in greater detail, is to provide a new and useful customer relationship management system which is not anticipated, rendered obvious, suggested, taught, or even implied by any of the prior art customer relationship management (CRM) systems, either alone or in any combination thereof.

The present invention is directed to a tool to assist users/customer managers in maintaining and developing future business prospects. The present invention uses an electronic mail (email) based “push” lead management tool that enables a customer manager or sales agent to efficiently and effectively communicate with a lead without learning new technology. The present invention uses email as a primary conduit for two-way communication with the customer management platform. The present invention further uses email communication to monitor the communication exchanges with the lead so that the lead is not forgotten by the user.

The present invention uses server side logic algorithms to make decisions for the user based on predetermined email responses instructing the user to take action. If the user does not respond to an email, the application follows-up on a lead by sending reminder emails requesting further action on the contact. For example, in one aspect of the present invention, an email is sent to the user who then clicks a button to give updates on the contact record. Server side logic decides when to ask the user for updates based on the most recent disposition. Based on this logic, trigger emails are then sent instructing the user what to do next while requesting more feedback. If the user does not open or respond to an email, the system has subsequent emails that are sent and alert the customer support department that the tool is not being used. Robust reporting then calculates the return on investment which can be communicated to the user.

The backside logic on the server allows the user to have the full benefit of such through simple email communication. The user is not required to access a website and can instead access all advantages of the program through simple email communication. There is no required software installation, instead the user can access leads and/or the return on his investment with only a click of a button.

Since backend logic is fully customizable, and replicates actions taken by user who would otherwise need to learn a complex graphical user interface commonplace with most contact management systems, the present invention can be applied across any industry that uses contact management systems.

The present invention is also directed to a system for facilitating client relationship management and includes at least one database resident on a server computer for storing lead data. A client relationship management software module resides on the server computer for updating lead data. An electronic mail update software module also resides on the server computer and is configured to provide instructions and request feedback. A return on investment software module resides on the server computer for reporting on value gained from using the system. These three modules serve to provide the operations of the present system. At least one port may be configured to exchange data with the server computer by a communication application.

In another embodiment, a computer readable medium contains instruction sets for a computer system and includes a computer-implemented client relationship management software module resident on a server computer for updating lead data. A computer implemented electronic mail update software module resides on the server computer configured to provide instructions and request feedback while a computer implemented return on investment software module resides on the server computer for reporting on value gained from using the system.

Another embodiment of the present invention provides a process for facilitating client relationship management and includes the steps of collecting lead data in at least one database resident on a server computer, executing a client relationship management software module resident on the server computer to update lead data, executing an electronic mail update software module resident on the server computer to provide instructions and request feedback, and executing a return on investment software module resident on the server computer to report value gained front using the system. Additionally and optionally, the process for facilitating client relationship management may include the step of transmitting new lead data to at least one port configured to exchange data with the server computer by a communication application.

Other embodiments of the present invention are set forth in more detail, below, and the embodiments set forth above are made for purposes of example only and not of limitation.

### BRIEF DESCRIPTION OF THE DRAWINGS

FIG. 1 illustrates a block diagram of an embodiment of the present invention that schematically shows important elements of architecture and operation of the present invention.

FIG. 2 illustrates a block diagram of an embodiment of the present invention that schematically shows the computer system of the present invention.

FIG. 3 is a flow chart showing a process by which an e-mail may be sent to the user under the present invention.

FIG. 4 is a schematic diagram of a first e-mail sent to a user.

FIG. 5 is a schematic diagram of a second e-mail sent to a user in follow-up to the first e-mail.

FIG. 6 is a schematic diagram of a follow up e-mail.

FIG. 7 is a screenshot of the previously purchased leads tab.

FIG. 8 is a screenshot of the show all leads tab.

FIG. 9 is a screenshot of the leaked details webpage.

FIG. 10 is a screenshot of the set reminder webpage.

FIG. 11 is a screenshot of the send e-mail webpage.

FIG. 12 is a screenshot of the preview e-mail webpage.

FIG. 13 is a screenshot of the lead report webpage.

FIG. 14 is an exemplary marketing report.

### BRIEF DESCRIPTION OF THE APPENDICES

The following appendices are incorporated herein by this reference thereto.

Appendix 1 is a How to Guide—Email-Based Customer Management for use in conjunction with the present invention

The appendices set forth above are incorporated herein by this reference.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

The masculine pronoun is generally used herein to indicate the generic individual and as a matter of convention and convenience.

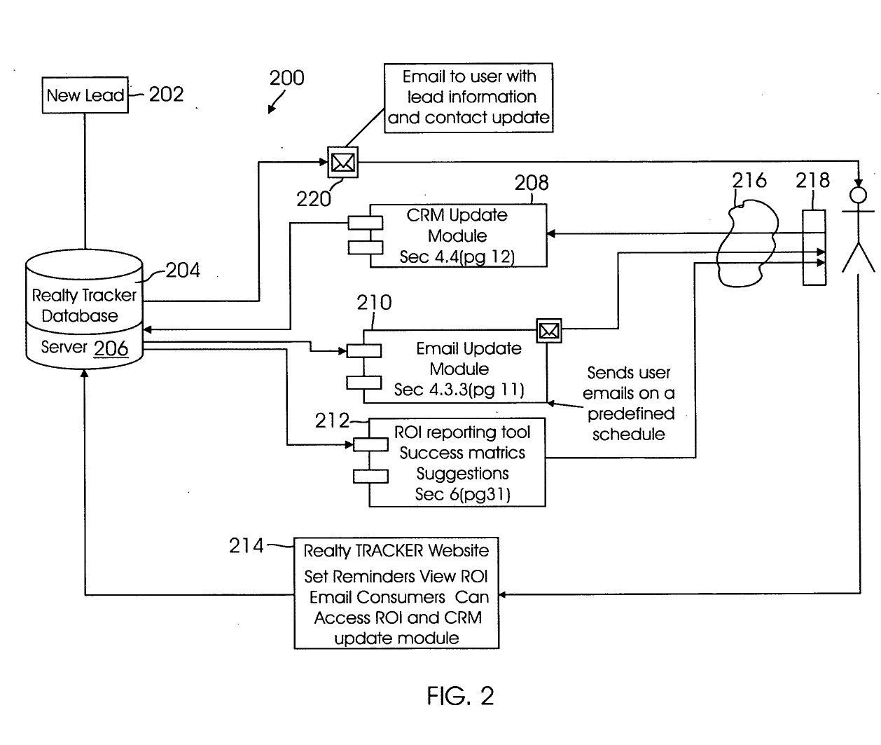

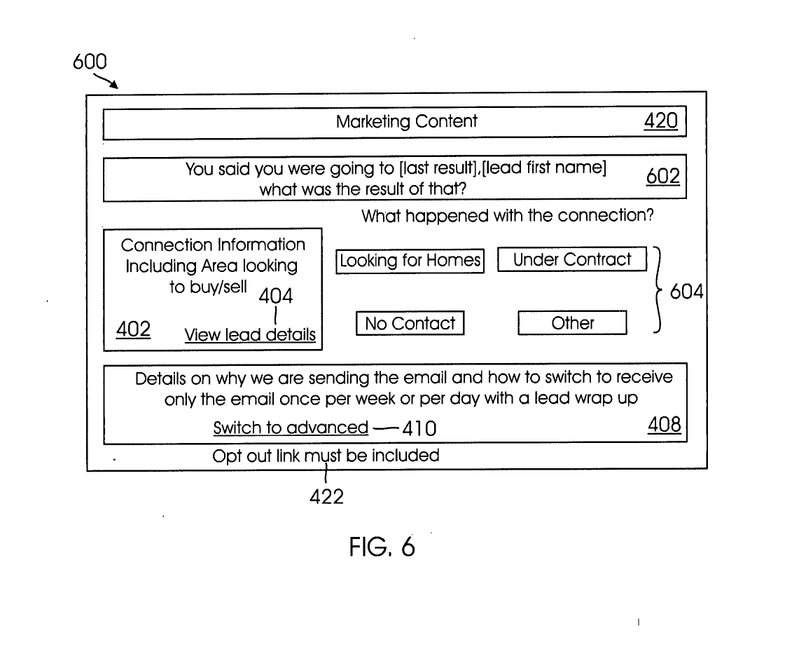

Additionally, the reference numbers used in conjunction with the Figures are numbered such that the 100's place of the number indicates the number of the drawing Figure. For example, the 600 series of reference numbers refers to FIG. 6, while the 200 series refers to elements shown in FIG. 2.

The present invention resides in a system for shifting the burden of reminders, particularly e-mail reminders, from the individual to an automatic system. By collecting additional information from the user/individual, the system is preprogrammed to collect additional information in the future and to guide the individual in the development of the contact. Leads may be obtained by or introduced to the individual via the present system with an anticipated future contact or other results indicated by the individual. According to the individual's response, the system then shepherds or prompts the user in the development of the contact. Consequently, much of the inconvenience that occurs with customer relationship management/CRM systems is shifted away from the user so that is much more easy to develop such contacts and to pursue other activities that are more beneficial while the housekeeping activities with regards to such CRM systems are handled by the automated processing system.

Referring to the drawings, where like numerals of reference designate like elements throughout, it will be noted that the following is a detailed description of presently preferred embodiments of the present email based push lead management tool for customer relationship management. However, the present invention is in no way intended to be limited to the embodiments discussed below or shown in the drawings. Rather, the description and the drawings are merely illustrative of the presently preferred embodiments of the invention.

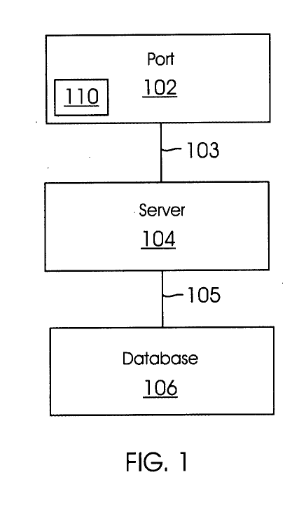

FIG. 1 is a block diagram of an embodiment of the present invention that schematically shows the computer system of the present invention. In the preferred embodiment, port 102 is informationally coupled to a server 104 such that the port 102 and the server 104 can exchange information. Server 104 is, in turn, likewise coupled to database 106. Port 102 can be any computing device capable of accessing other computers in a networked environment including a personal computer, a hand held computer, a personal digital assistant, internet terminal, mobile device, smart phone, and the like. Port 102 is preferably a personal computer having a processor, a printer, an input device such as a keyboard and/or mouse, a monitor, a floppy disk drive, memory, a modem and/or computer network interface, and a mass storage device such as a hard disk drive and/or a CD-ROM drive. Port 102 may operate under the control of an operating system such as MS-DOS, WINDOWS OS, OS/2, UNIX, LINUX, MAC OS and the like. In one embodiment, port 102 is operable to run a web browser.

Web browser program 110 is operable to communicate with server 104 using a protocol such as HTTP. Web browser program 110 is operable to receive information in a mark-up language such as HTML from server 104 and output a formatted display. Web browser program 110 allows a user to enter the web address or uniform resource locator (URL) of an Intranet, Extranet, or Internet page will retrieve information from server 104 and display the information on port 102. In the present invention, the user of port 102 will utilize web browser program 110 on port 102 to access email accounts to ascertain the status of and communicate with certain leads and determine the return on investment on each lead pursued.

A communication line 103 couples port 102 with server 104. Communication line 103 may be any type of communication link capable of supporting data transfer. For example, these communication lines may include any combination of an integrated service digital network (ISDN) communication line, a hard wired line, a telephone link, a digital subscriber line, a cable connection, a fiber optic link, or a wireless connection. Communication line 103 will support the transfer of an HTTP stream between client computer 102 and server 104. The HTTP stream maybe compressed for efficiency purposes and encrypted for security purposes.

Server 104 is a computer, such as a personal computer, file server, work station, minicomputer, main frame, or any other computer capable of communicating and interconnecting with other computers. Server 104 will preferably include a processor, an input-device such as a mouse and/or keyboard, a monitor, memory, a modem or other means of communicating with other computers, a mass storage device such as a hard disk drive or optical disk drive and a floppy disk drive. Server 104 will operate under the control of an operating system such as Windows OS, Unix, Linux, Macintosh OS and the like. While server 104 is shown as a single computer, the functionality and data storage can be distributed throughout one or more computers in communication with each other.

A communication line 105 connects server 104 with database 106. As previously discussed communication line 105 may be any type of communication link capable of supporting data transfer. The exact method of accessing databases is a design choice that can be varied by one skilled in the art.

Database 106 holds information such as the contact information on each lead, the status of each lead, aggregate data for closed transactions, etc. The information may be provided in a single database or multiple databases. Server 104 can access database 106 directly or by using a middleware application such as Java Database Cartridge or an Oracle Database Cartridge made by ORACLE. Alternatively, an extensible mark-up language (XML) database can be used along with an XML parser to select database entries from database 106. Alternatively, in another embodiment, database 106 may reside on server 104.

Alternatively, the user can access ascertain the status of and communicate with certain leads and determine the return on investment on each lead pursued through a web site also running on a web serve application on the server 104. In that instance, the web server application will be operable to host a web site. The type of web server application used would depend upon the operating system running on the server 104. For example, if the server 104 is running a UNIX operating system, the web server application 114 may be an Apache web server application.

FIG. 2 is a block diagram of an embodiment, of the present invention that schematically shows the computer system 200 of the present invention. Data associated with new lead 202 is maintained in database 204. Database 204 can be a disk, hard drive, data repository, or any other form of data storage device known to those familiar in the art. In the preferred embodiment, new lead data includes name, address, contact information such as telephone numbers, emails, etc., a description of the customer, property, and other pertinent information. Database 204 is coupled to server 206 in the manner as previously discussed in FIG. 1. Alternatively, database 204 may reside on server 206.

In the present embodiment, resident on server 206 is customer relationship management module 208, email update module 210, and return-on-investment module 212. Alternatively, customer relationship management module 208, email update module 210, and return-on-investment module 212 may reside on a separate or independent computer coupled to server 206. Customer relationship management module 208, email update module 210, and return-on-investment/ROI module 212 transmit data over Internet 216 to port 218. Alternatively, data may be transmitted from server 206 to port 218 over an intranet or local network. As before, port 218 can be any computing device capable of accessing other computers in a networked environment including a personal computer, a hand held computer, a personal digital assistant, internet terminal, mobile device, smart phone, and the like. Port 218 is configured to receive and transmit data with server 206 in the form of electronic mail message 220.

Port 218 is further configured to access website 214. Website 214 is hosted by server 206 and enables the user of port 218 to set reminders, view and track specific leads, communicate with leads, and access return-on-investment module 212 and customer relationship management module 208. In the preferred embodiment, website 214 is run on a web serve application resident on server 206. The process of the present invention commences when the user purchases a lead. Once a lead is purchased, the customer relationship management module “pushes” data associated with a new lead in the form of an email as described above. The first email includes information associated with the lead and requests instructions from the user on what he plans to do with the lead.

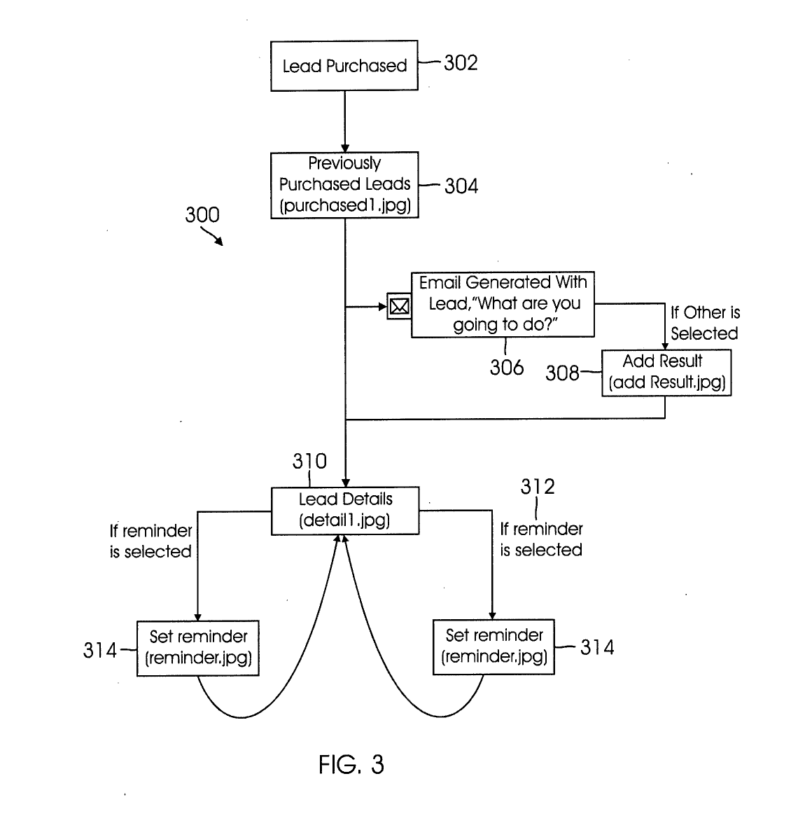

FIG. 3 shows schematically one embodiment of the present invention where leads purchased 302 are added to currently and or/previously purchased leads 304. Concurrently or otherwise, an e-mail may be generated with the addition of the lead. The e-mail may inquire as to what should be done 306. If the selection is “other,” the result is added 308 and as for the step subsequent to the previously purchased leads step 304, control is passed to lead details 310 where the details for the lead may accordingly be confirmed and/or edited. If a reminder is selected 312 then the reminder is set 314 and the lead the details 310 are updated.

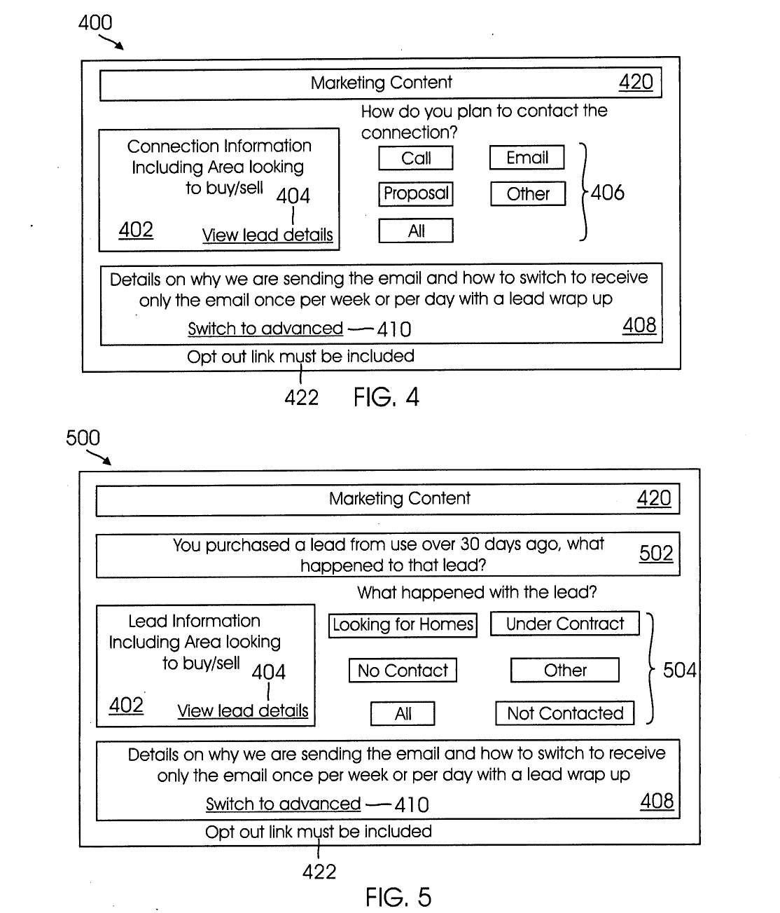

FIG. 4 is an exemplary diagram of a first e-mail sent to the user. The first e-mail 400 contains connection information for 402 as well as response buttons 404 that enable the user to signal how contact is to be made with the connection/lead.

The first e-mail 400 generally includes connection information as well an inquiry/confirmation of what the realtor/lender plans to do with the new lead. As such, the initial e-mail contact shown in FIG. 4 contains a variety of specific elements that are somewhat consistent throughout the e-mail messaging operations that occur in the present invention.

Connection information 402 is provided that may include the area where the contact/lead is looking to buy or sell property. As with many of the elements of the e-mails communicated ii the present system, a hyperlink enabling the e-mail recipient to view the lead details 404 may be present and associated with the connection information for 402. After inspecting the connection information for 402, the recipient may desire additional information and obtain the same by clicking on the “view lead details” hyperlink for 404 which will then take the recipient to a website (such as a recipient's user-specific website) that provides additional details regarding the lead.

In this way, the e-mail for 404 provides generally complete and sufficient information for the recipient regarding the new lead while also enabling the recipient to access additional information that may be useful in assessing, evaluating, or otherwise the lead brought to the recipient's attention via the initial e-mail 400. In this way, the recipient of the e-mail can generally be given access to as much information as is necessary or desired for the lead.

An array of response buttons for 406 are provided in an exemplary fashion in FIG. 4. These response buttons provide the e-mail recipient convenient and spontaneous means by which he can indicate in what manner he plans to contact the connection/lead. In one embodiment and as shown in FIG. 4, buttons are provided that enable the e-mail recipient/user to call, e-mail, submit a proposal, submit other information or all of the foregoing means by which to follow-up on the initial lead e-mail 400.

Other response buttons could also be included and it may be possible to have the e-mail recipient to design his own e-mails from a palette of response button choices or the like with a database preserving the information over extended periods of time.

Certain standard features may be incorporated into the e-mail 400 such as specific details 408 as to why the e-mail is being sent and a switch enabling changes to different formats (such as one that has the e-mail recipient only receiving the e-mail once per week or once per day with a lead wrap-up). Such a lead wrap-up 410 may encapsulized the lead connection information and provide response buttons for each separate contact. As such, weekly or daily digests of available or new leads could be transmitted to the e-mail recipient on the basis that is determined by the user's/e-mail recipient's preferences and not those imposed by a system manager or software program designer. Included in the details may be a “switch to advanced” hyperlink for 410 that delivers such format control via an online website or the like to the user/e-mail recipient.

Marketing content 420 specific to the user/e-mail recipient, the provider of the e-mail system of the present invention, or otherwise, may be incorporated into the e-mail 400. In fact, almost any e-mail element that is presently incorporated in e-mails today or e-mails foreseeably (or otherwise) incorporated into the e-mails of the present system.

An opt out link 422 may be provided at the bottom of the e-mail 400 or otherwise. Such opt out links may be mandated by law. Additionally, any other notices or options that are mandated by government or regulatory body could also be incorporated into the e-mail 400 just as the opt out link 422.

If one of the response buttons in the array 406 is clicked, the response is noted by the system. If not, another e-mail 500 as shown in FIG. 5 may be transmitted from the system including several of the elements of the e-mail shown in FIG. 4 as well as an inquiry banner 502 and an array of response buttons 504 enabling the user/e-mail recipient to indicate to the system what has happened to the lead. In one exemplary embodiment shown in FIG. 5, the user may indicate that the lead is looking for homes, under contract, but no contact has been made, that some other event, situation, or status as been achieved, that all of these foregoing circumstances have occurred, and/or that the lead has not been contacted. Other response buttons may be made available or put to use by or for the user in a manner similar to that as set forth with respect to the array of response buttons for 406 of FIG. 4.

It is assumed that the user subscribes to the system set forth herein for purposes of customer/lead relationship management. As result, although other steps could occur in the contemplation of the present system, if the user/e-mail recipient chooses not to respond to the follow-up e-mail 500 as shown in FIG. 5, further action (such as additional e-mails) or otherwise may be taken or no action may be taken at all as the system may be programmed to consider the lack of response indication that no interest by the user is present in the lead submitted for review. In any case, after a period of time has elapsed, for example, seven days, a second e-mail may be sent to the user/e-mail recipient inquiring with regards to what happened to lead and allowing the user to respond thereto.

The second e-mail 600 may have several common elements shared with the e-mail 400 shown in FIG. 4 and these are marked with same reference number. The inquiry banner 602 of email 600 may prompt the user to respond to the inquiry as to the result of the last event for the related to lead/contact. Consequently, as shown in FIG. 6, the inquiry banner 602 has certain phrases framed in brackets. These brackets indicate alternative text which may be used within the enframing brackets.

For example, if in response to the first e-mail 400, the user said that he was going to “call” the lead set forth in the connection information 402, “Mr. Jack Jones” then inquiry banner 602 in FIG. 6 would read as “you said you were going to call Jack. What was the result of that?” Alternatively, the [lead first name] could be “Mr. Jones,” “Jack Jones,” or the like in such a manner that the lead is specifically indicated in a manner that is readily recognizable by the user. Due to the flexibility of database operations and programming, information having little context, such as numbers, are avoided so that the user does not have to look up which number corresponds with which contact.

The present system tries to provide as much convenience for the user as possible so that he or she can go forward with managing the contact and a relationship therewith rather than spending time having to wrestle with electronic information systems or the like. By freeing up the user/subscriber, great convenience and advantages are provided so that the introduction of new leads and/or contacts into the business of the user are as seamless as possible. This may make the present system set forth herein very attractive to those who are leading dynamic entrepreneurial businesses for themselves and/or others and who want to deal with those things that matter to the business rather than those things that support the business.

As shown in the e-mail 600 of FIG. 6, an array of response buttons 604 is provided to the user/e-mail recipient in order to allow response to the inquiry set forth in the inquiry banner or other inquiry question 602. In the exemplary embodiment shown in FIG. 6, the array 604 of response buttons enables the user/e-mail recipient to respond to the question “what happened to the connection?” The choices shown in FIG. 6 include response buttons enabling the user to indicate that the connection/lead is looking for homes, under contract, but no contact has been made, or that another situation is in effect. As for the other response button set forth herein, this list is not exhaustive.

It should be noted that the response buttons indicated above for FIGS. 4-6 are generally those that would enable a concise and complete response to the inquiry prompts that are given to the user by the respective e-mails. As interactivity is currently under development with respect to such e-mails, messaging systems, and the like, such response buttons should be considered in light of the developing technology that is now known or realize in the future. Consequently, the interactivity provided by the e-mails set forth as an exemplary embodiment of the present invention should be considered as a possibly primitive embodiment of nascent technology.

Additional update e-mails are also sent. Such e-mails are generally grouped within the database with the database used in the present system to allow for additional dispositions.

For example, a subsequent e-mail may go out after approximately 30 days of the first e-mail 400. Such an e-mail may have the appropriate inquiry/inquiry banner and may have response buttons that allow the user to indicate that the contact is either looking for homes (if the contact is a buyer) or if the contact/lead is under contract (for a seller). Additional e-mails may be sent at 90 days and 180 days with response buttons available to indicate that the contact/lead may not be available for or may not make a decision for 3-6 months or 6-12 months respectively.

The e-mail set forth above may have a variety of roles and goals with respect to the user and the system set forth herein. For the initial e-mail 400 set forth above, and the examples set forth herein, realtors and mortgage brokers may be a class of individuals corresponding to the users/e-mail recipients. When the user purchases a lead, he generally clicks on it or otherwise indicates that he wants to purchase it or a lead is sent to him via an auto-lead delivery system (ALD) that transmits an e-mail such as those set forth above. Once the lead is purchased, the system adds the lead to the list of leads present in the specific user's main database entry the lead may be associated with a “previously purchased lead” tab present on a website or webpage summarizing and providing access to the user's account within the system.

The ALD system present within the present invention transmits to the user the appropriate e-mail message with the lead contact information and optionally appropriate response buttons. When multiple leads are purchased on a daily and/or weekly basis, the present system provides means by which to establish an association between the user and each lead, keeps track of the status of the leads with respect to the user, and prompts the user to take action and/or update status with respect to the progress of commercial activities relevant to each lead.

When the first lead e-mail 400 is received, the user receives the e-mail with the lead contact information. This provides the user the information necessary to establish a professional/business relationship with the lead and to possibly pursue a commercial transaction with same. A response button array 406 enables the user to select a disposition of the contact in the e-mail and provide spontaneous and immediate feedback to the system with regards to the user's plans for contacting lead. When the disposition is selected by clicking on one of the response buttons in the array 406, the user is taken by the system to the “update disposition” page. This update disposition page may be a webpage provided and possibly spontaneously generated by the system enabling the user to access relevant information in the user's account with response to the lead sent in the e-mail.

The system preferably stores the information on what disposition was selected by the user. The user has the option to add notes or change the disposition of his webpage. If the user does not change the disposition or selects “submit,” the system preferably stores the disposition initially selected from the e-mail. If the user does not select disposition on the or from the e-mail, the system preferably keeps the disposition on the default setting which, for example, may be “no action taken.”

If the disposition status for the lead provided to the user in the user's account indicates that no action was taken from the e-mail, the user then receives a follow-up e-mail 500 as shown in FIG. 5. This follow-up e-mail then enables confirmation that the e-mail was received by the user and enables possible follow-up by the system should e-mail communications somehow fail between the system and the user.

Alternatively, if the user responds from the response buttons array 406, then the second e-mail 600 is only transmitted to the user after seven days or some other appropriate period of time.

When e-mails are not updated or provided a response by the user, the system may send out an e-mail on the following day indicating such lack of response. If this follow-up e-mail receives no reply, the same e-mail may be sent again after seven days or other appropriate period of time. If no response is received from the user with regards to this follow-up e-mail, the system may attempt one more time to contact the user with a second “no response” e-mail. After this point, the lead may be abandoned with respect to the user and the database entry on the users account for the lead may be removed, held in the abeyance, placed in a dormant status, or otherwise. Additionally, other evaluations can take place whether or not the user responded to other e-mails if other leads are associated with the user.

As indicated above in e-mails shown in figures for 4-6, it is possible for the user to opt out of e-mail portion of the system. If the user does opt out, the user may still be able to access his information via a web-based aspect of the present invention wherein status of new and old leads as well as the availability and dispositions with regards to those leads may be made available to the user.

In one example, realtors may opt out of several aspects of e-mails prepared and transmitted by the present system. These include lead update e-mails, new leads in your area e-mails as well as e-mails regarding purchased lead information, service updates/offerings, CRM e-mails, receipts, weekly newsletters, “my tracker” e-mails, and/or approved partner e-mails related to a system operating under the present system herein.

With respect to leads that are participating the present system, opt out options include opting out of e-mails related to status (including proposals, marketing, and/or welcome e-mails), CRM realtor generated e-mails, and/or approved partner e-mails relevant to the system disclosed herein.

Generally, a user (either a realtor or lead) can opt out of any and all of the e-mails. The system preferably allows modification in order to check the database to see if the e-mail can be sent. The table below sets forth some exemplary categories of e-mails and possible categories with respect to the opt out option set forth herein. It should be noted that the term “RealtyTracker” may be a trademark that may have been used or is in use in conjunction with a system implementing the present invention

| Email | Opt Out Group |
|---|---|
| AccountCreated broker | 10 |
| AccountCreated buyer | 10 |
| AccountCreated homevalue | 10 |
| AccountCreated seller | 10 |
| AgentSearchEnded | 10 |
| alertEmail | RT internal |
| alertErrorEmail | RT internal |
| AutoDeliveryCell-Type1 | 3 |
| badLeadCredit | 4 |
| basiclistingEmail | 8 |
| CC ansMachineEmail | Deprecated/ |
| | Discouraged |
| CC callBackEmail | Deprecated |
| CC noAnswerEmail | Deprecated |
| Chosen | 10 |
| Chosen broker | 10 |
| Contract Approved | 4 |
| Contract CC Declined on Monthly | 4 |
| Charge | |
| Contract Not Returned | 4 |
| Contract Sign Email | 4 |
| Contract Update Service Area | 4 |
| ContractProposal-Lender | 1 |
| ContractProposal-Realtor | 1 |
| DeclinedEmail | 10 |
| Delete invited vendor | 8 |
| emailPassword | 4 |
| emailSupport | RT internal |
| Error Email | RT internal |
| FeedbackPosted | 4 |
| FeedbackPosted broker | 4 |
| firstMonthTrialConfirmationMails | 4 |
| FoundAgent | 10 |
| FoundAgent broker | 10 |
| FreeRegistrationConfirmation | 4 |
| FreeRegistrationConfirmation_mortgage | 4 |
| broker | |
| FreeTryConfirmationMails | 4 |
| inivitation | 8 |
| leadBuyerContactInfo | 3 |
| leadMortgageContactInfo | 3 |
| leadSellerContactInfo | 3 |
| message waiting | 8 |
| MultiLeads-Lender | 3 |
| MultiLeads-Realtor | 3 |
| packageCreatedEmail | 4 |
| PackageProposal-Lender | 1 |
| PackageProposal-Realtor | 1 |
| paidConfirmationMails | 4 |
| paidConfirmationMails broker | 4 |
| PersonalizedBrokerCampaign | 1 |
| PersonalizedBrokerFree | 1 |
| PersonalizedBrokerNewPaid | 2 |
| PersonalizedBrokerPaid | 2 |
| PersonalizedFreeRealtor | 1 |
| PersonalizedNewPaidUserEmail | 2 |
| PersonalizedPaidUserEmail | 2 |
| premiumlistingEmail | 8 |
| ProposalPosted | 10 |
| ProposalPosted broker | 10 |
| Realtor Register - B | 1 |
| Realtor Register - C | 1 |
| Realtor Register - D | 1 |
| Realtor Register - E | 1 |
| Realtor Register - Index | 1 |
| Recurring Billing Receipts | 6 |
| RenewalInvoice | 6 |
| RenewalStopped | 4 |
| Return Path Test 1 | RT internal |
| Return Path Test 2 | RT internal |
| TellAFriend | 10 |
| Vendor Email | RT internal |

NEW EMAILS

| | |
|---|---|
| Lead Sent | 5 |
| First Email Not Clicked | 5 |
| Second Update Email | 5 |
| Additional Update Email | 5 |
| No Action taken | 5 |
| What Happened to the lead? | 5 |
| Reminder Email (realtor set) | 5 |
| Personalized Realtor Emails to Leads | 11 |

Opt Out Group Key
Realtors
1. Marketing Emails (free user)
2. New Lead in your area (paid user)
3. Purchased lead information email (includes cell phone email)
4. Information Emails
5. CRM Emails
6. Receipts
7. Weekly newsletter (weekly email)
8. My Tracker emails
9. Approved RealtyTracker partner emails
Leads
10. Status emails (includes proposals, marketing, welcome)
11. CRM Realtor Generated Emails
12. Approved RealtyTracker partner emails

Generally, in a preferred embodiment, all users are opted in to all e-mails. If ALD (auto-lead delivery) is opted out, the user preferably has their leads deducted from their lead bank and such leads may be displayed in the previously purchased lead tabs when a user accesses his specific website.

The present system also includes a website for customer relationship management/CRM along the lines indicated somewhat by the descriptions of the contact/confirmation/status e-mails for contacts/leads set forth above. Generally, it is the goal of the present system to provide an easy to use, preferably intuitively obvious, user interface so that the bookkeeping/data management is handled at a minimum by the user and at a maximum by the system. This requires that certain programming steps be taken in advance in the context of the user interface/programming system may lead to certain operations, features, and functions that are easily used by the user.

In one scenario, when a user receives an e-mail with a lead's contact information, the user may select a disposition in the e-mail, such disposition being transmitted back to the system for recordation and further use. When the disposition is selected, the system takes the user to the “update disposition” page. This page is generally user-specific and is different for each individual user. This is so because each user has a different geographic region, different customer base, and generally different leads/contacts in their lead bank.

When the user is sent to the disposition page, the system generally stores the information for future use. As set forth above, the user has the option to add notes or change the disposition and if the user does not change the disposition or select “submit,” the system generally stores the disposition initially selected from the e-mail. In fact this is the preferable operation by the system so that the user's choice is not lost.

A variety of interface presentations may be made, but generally after the user has designated his choice on the disposition page, the system generally displays the update disposition page and the user may make any notes desired. The user may then click “submit” and the system then stores/record the information for later use in the user is returned to the “lead details” page. If the user forgets or neglects to click “submit” on the disposition page, the database preferably stores the disposition the user clicked on in the e-mail. Generally, the system tracks events relating to the transmitted lead every time an e-mail is sent whether or not it was opened, what disposition was clicked, or any other event related to be transmitted e-mail.

The CRM tool of the present invention may be embodied in a website or otherwise. The terms CRM tool and website they be used interchangeably herein, the context generally determining what is meant by the use of these terms.

When a user goes to the CRM tool, the user is generally directed to the “view leads” page. The user may then click on the “previously purchased leads” tab and the system will generally return the leads that the user has purchased. When the user clicks on a link for the details on any one (or more, optionally) of the leads, the user is then presented with (or taken into) the lead details page for more detailed information with regards the lead. Multiple windows may be opened up at once for the convenience of the user and the user may be able to specify system options with respect to the operation of the previously purchased leads entries. Preferably, every time a lead is updated, all information is stored for later use. This may also include time, date, and disposition.

As a result of the CRM tool, e-mails may be a collateral convenience for the user as e-mails may be turned on or turned off at will. Such e-mails are generally generated from the data present in the database. New leads may then be added to the user's specific database entries and the user may either become aware of the new lead by the e-mails as set forth above or by accessing the CRM tool/website/other information presentation system.

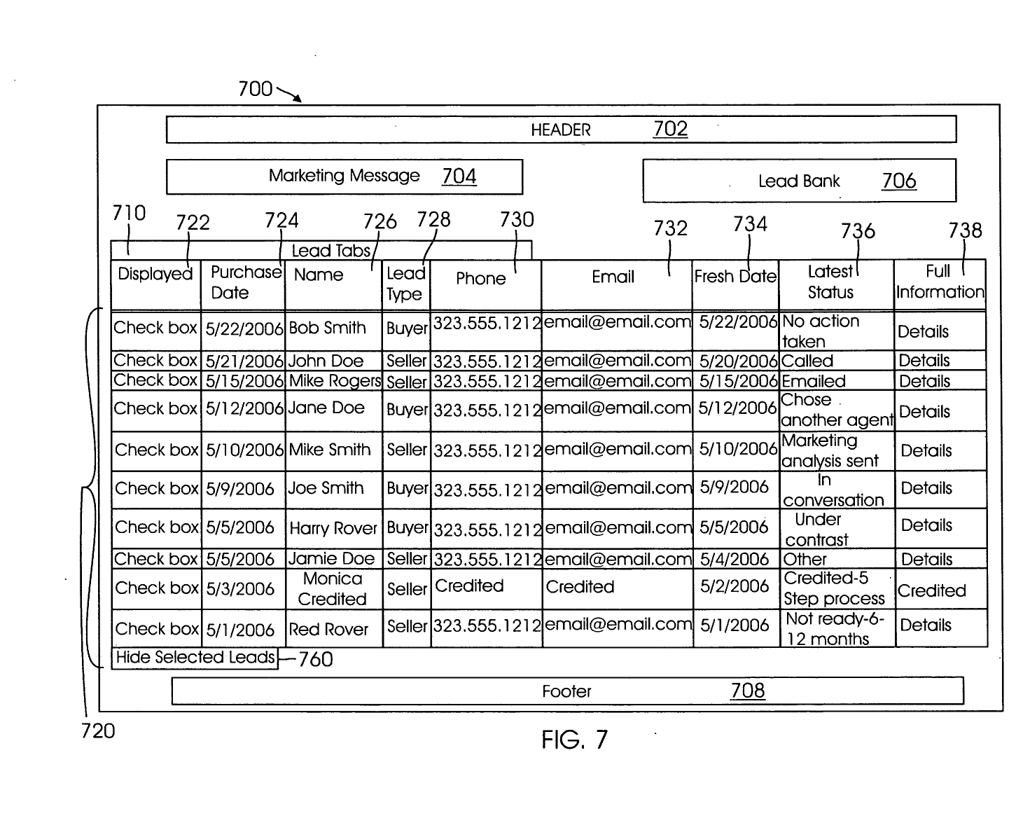

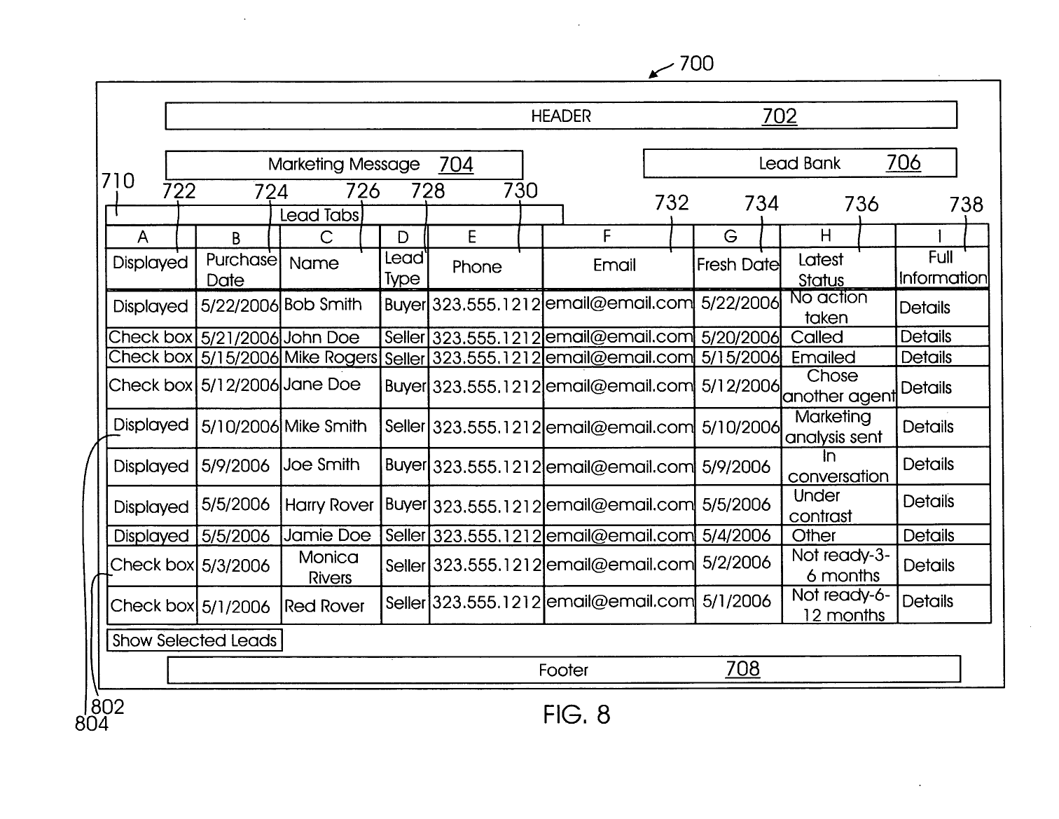

Turning now to FIG. 7, selection of the “previously purchased leads” tab will lead the user to a webpage that enables him to see all leads that he has purchased even if a credit has been issued. When a user goes to the “previously purchased leads” page, all leads that have been purchased by the user will be displayed. Additionally, relevant contact information may be provided for each user when appropriate. If credit has been given for a particular lead, the system will display the lead, but certain information will not be shown. Generally, leads that have had credits issued can no longer be updated in the CRM tool.

FIG. 7 shows the “previously-purchased leads” webpage 700. A header 702 may provide information relevant to the webpage 700 and as with the marketing message 704 and the lead bank 706, the header 702 may be allocated a certain specific space on the webpage 700. These fields generally provides a template into which information may be inserted and updated, possibly dynamically. In a similar manner, a footer 708 may be present that provides reference information with regards the webpage, the user account, and/or otherwise.

Lead tabs 710 may be present and, while only one is indicated in FIG. 7, for a user account having several leads, it may be more convenient to have different tabs to provide listing of leads on a single page only. That is, only a visual page's worth of leads may be shown at one time with the number of tabs above the leads matching the number of pages necessary to show or provide access to all of the leads.

The leads 720 are shown in a variety of columns and may include sortable headers as far as the display status of the lead (designated as by checkbox or the like), purchase date 724, lead name 726, the type of lead 728, the phone number for the lead 730, e-mail for the lead 732, relevant date information 734, the latest status information 736 (possibly in summary form), and a column providing links regarding the lead's full details 738.

As can be seen for the next-to-last row, a certain seller, named Monica, has been credited 750. The crediting process has been mentioned above, and consequently certain information is generally not available for this lead.

In FIG. 8, certain leads may optionally be hidden by the user to allow for a clearer and more relevant presentation of the lead information. Generally, this is thought to provide a more relevant user interface as only those leads of interest to the user are presented according to the choices made by the user.

As indicated above, a checkbox column may be present 722 that enables a user to select certain one of the leads, generally by row as indicated in FIGS. 7 and 8. For example, for the checkboxes (shown in literal text and not a graphic checkbox) as shown in FIG. 7, a user may click on one of the checkboxes to indicate which leads should be hidden. As FIG. 7 might be considered to currently show all leads, a “hide selected leads” button 760 may be present that serves to implement the process by which those leads that have been selected are hidden. The results are shown generally in FIG. 8.

In FIG. 8, like elements are given similar reference numbers as those in FIG. 7. Of note is the column designated “A” where some of the rows are tagged with the phrase “displayed” 804 while others are tagged with the phrase “checkbox” 806. For purpose of example, those with the phrase “checkbox” could be considered hidden leads while those with the “displayed” phrase could be considered those leads which are displayed. In one embodiment, the entries for leads that are “hidden” could be shown in diminished or less prominent typeface so that they were visually less intrusive or noticeable to the webpage as a whole. However, a checkbox for each of such hidden leads could be maintained so that the hidden aspect of such leads could be altered at will by the user. In FIG. 8, instead of the “hide selected leads” 760 button, a “show selected leads” 810 button may be present to control the visibility of the selected leads shown in webpage 700. The “show selected leads” button 810 may be interchangeable with the “hide selected leads” button 760 according to the purposes of the webpage 700.

As indicated above, all the leads in the webpage 700, or at least those shown under the selected tab, have a checkbox in the left-hand column 722. When the user clicks on a checkbox associated with a certain lead (and more than one checkbox may be checked) and when the user clicks on the “hide selected leads” button 760, the system flags the leads in the database so the leads are not displayed by default. The system will refresh the page such that the leads that are selected to be hidden are no longer displayed.

By default, all leads are displayed and the system should display only leads which are not hidden. Even though they are hidden, leads can still be updated from e-mails. If no leads have been purchased, and image with a message “no leads purchased” or the like may be displayed.

Additionally, with reference to FIG. 8, a “show all leads” button may be made available to the user in order to enable him to show all the leads he has purchased. When the “show all leads” button is clicked, the system displays all leads. The first column on the left of the lead table will generally show the status of the lead and may either say “displayed” or will have a checkbox. The user may select the lead or leads he wants to be displayed and then click the “show selected leads” 810 button. The system sets those leads to be displayed system then sets and/or displays those leads which have been selected to be displayed by default and then sends the user back to the “previously purchased leads” tab. As mentioned above, the system should generally display all purchased leads on the page regardless as to whether or not they were set to be hidden or displayed. If no leads have been purchased, a message similar to that described above indicating “no leads purchased” or the like may be displayed.

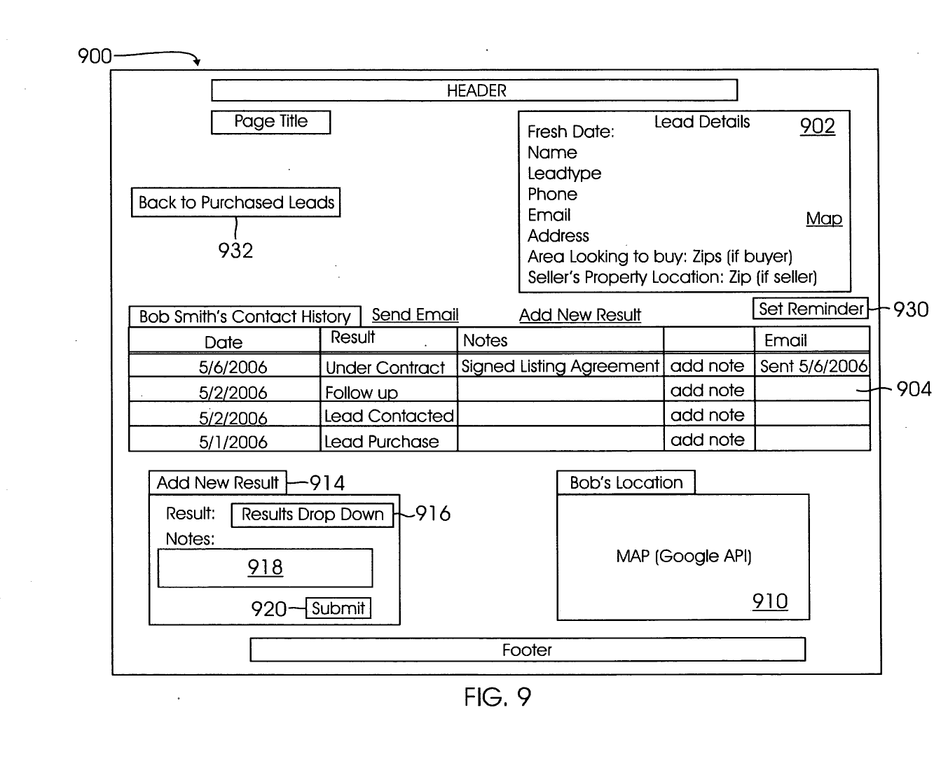

Is FIG. 9 shows the “lead details” page which is presented to the user when the “details” link or button is pressed from the full information column 738 of the lead table 720 (FIG. 7). When the user clicks on the “details” link from one of the leads as from the previously purchased leads tab as shown in FIGS. 7 and 8, the system displays all relevant information 902 on the selected lead including the full contact information and where the lead is looking to buy. The system also may display the last 20 (for example) dispositions with any notes for the lead the user clicked on in the disposition table 904.

These lead details page 900 may also display the area where the lead is looking to buy or sell in a map 910 or otherwise. Generally, the system grabs the first zip code in the search criteria and displays a map, such as a Google™ map, as part of the lead details page 900. This gives the user at least a general idea of the location where the lead is looking to conduct the transaction.

The user call select or choose to add a new result by clicking on a new result link 914 and a new note can be added by selecting a result indication from a results drop-down menu 916. Additional information about the lead may be placed in a notes section 918. A “submit” button 920 activates the system to store the information in the database and refresh the lead details page 900.

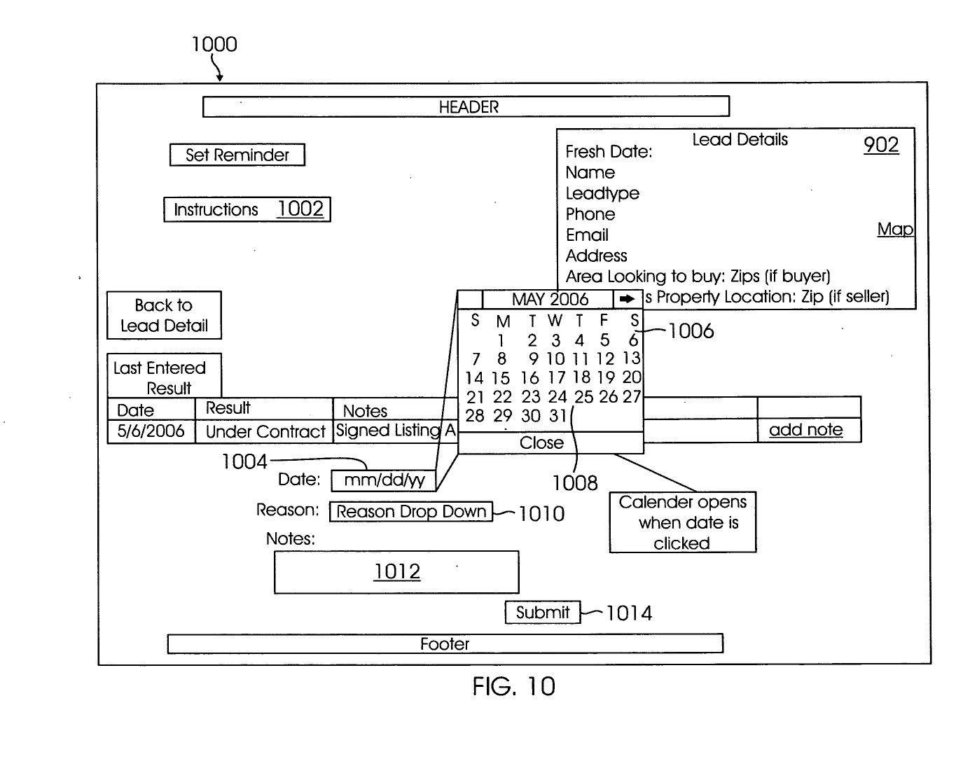

A set reminder button 930 may be present as may be a “send e-mail” button (not shown). By clicking on the “set reminder” button 930, the system takes the user to the set reminder page (FIG. 10). Additionally, the user may return to the purchased leads page (FIG. 7) by clicking on the purchased leads button 932. Additional information may provide a common motif to the website and may include a header, page title field, footer, and the like. These elements are shown in the Figures and may be similar from page to page in the web-based CRM tool.

In FIG. 10, the set reminder page 1000 is shown. The set reminder page may be accessed by a set reminder link on other webpages or it may be accessed directly by the user. The set reminder page 1000 generally displays the latest lead disposition with all notes for the particular lead. The lead details information area 902 may be similar as that for FIG. 9, as may be the header, the page title field (here, shown as “set reminder”), and the footer. An instructions field 1002 may also be provided.

By clicking on the date field 1004, a calendar 1006 may be displayed that enables the user to click on one or more particular dates 1008. Upon so doing, the system will automatically populate the date field in a manner that is very convenient for the user. The user may then select a reason from the reason drop-clown menu 1010 and upon choosing one of the predetermined reasons or otherwise, the user may add notes in the notes field 1012. Upon entering the information solicited from the user by the set reminder webpage 1000, the user may click the submit button 1014 to store the information in the database.

On a periodic basis, such as nightly or in the early morning, the system can then run an appropriate job collecting all of the reminders from all of the leads for all of the users and send out the reminder e-mails. On the day that the reminder was indicated by the user, the system will generate an e-mail to the user with reminder information including all lead contact information, the reason for the reminder, any notes, or otherwise as is useful for the user.

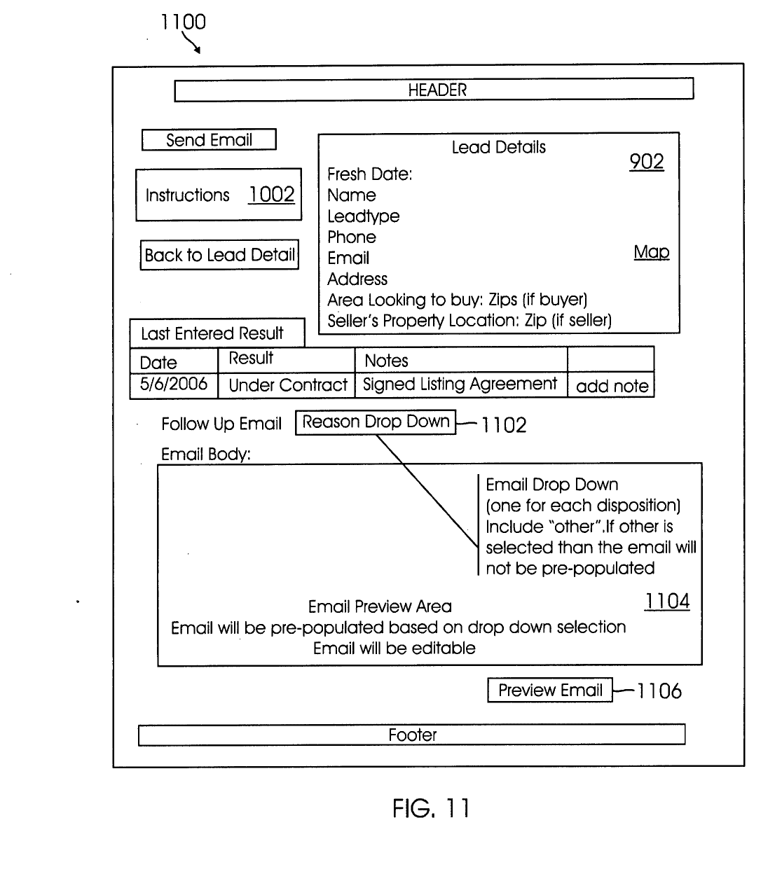

Users can send e-mail to one another, to themselves, and possibly to others. FIG. 11 shows a send e-mail page 1100 having features similar to those webpages shown in FIGS. 9 and 10. By clicking on a send e-mail link (not shown) that may be present on any one of the several webpages as appropriate, the user may be taken to the send e-mail page 1100. Of considerable advantage in the present system is the fact that the e-mail will be pre-populated by the system with selectable content that the user may choose. Beyond this, the user may also edit the content of the e-mail to add specific information or text.

Upon clicking a send e-mail link (not shown) or otherwise, the system sends the user to send e-mail page 1100. A reason drop-down menu 1102 enables the user to select a reason for the e-mail in a manner similar to that as for the lead dispositions 916 (FIG. 9) or otherwise. Upon selecting the reason with the reason drop-down menu 1102, the system can populate the e-mail body section with the appropriate e-mail text. Any adjustments to the e-mail body 1104 can be made by the user. The preview e-mail button 1106 can be clicked to enable the user to preview the e-mail. Generally the “reply to” and “from” fields should be from the user sending the e-mail and generally not the system sending the e-mail or the service implementing this system. A profanity filter can be added to the e-mails which may prevent the user from leaving the preview page of profanity is detected. The system may also check to confirm the lead is opted in for CRM e-mails. The user may be notified that the e-mail cannot be sent as the lead has chosen to opt out of such e-mails.

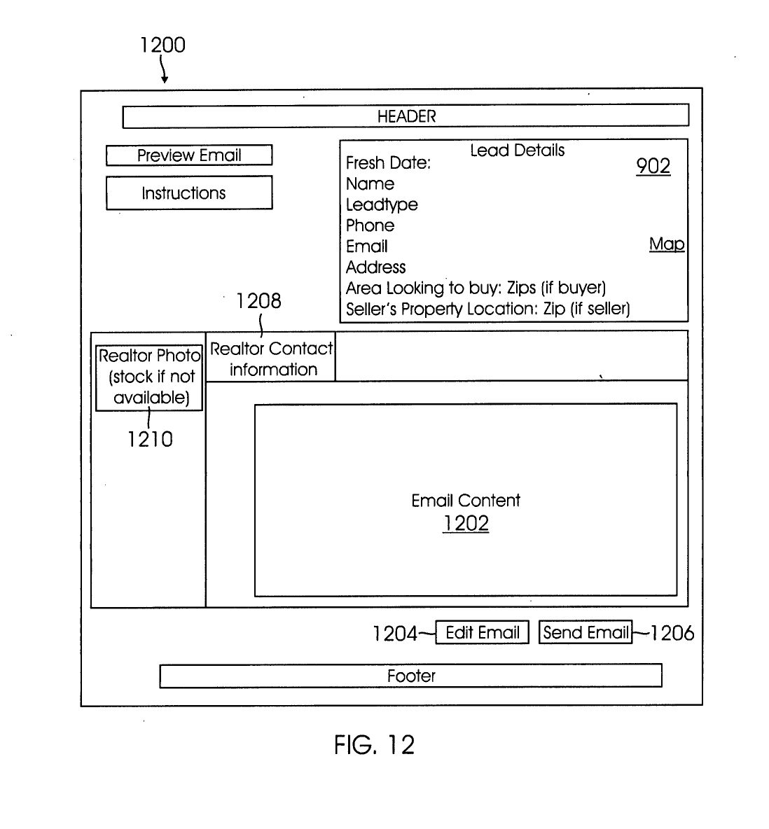

A preview e-mail page 1200 is shown in FIG. 12. This page enables the user to see how the e-mail will be presented to the consumer or recipient via the e-mail content frame 1202. If additional edits need to be made to the e-mail, the user can click the edit e-mail button 1204 to return to the prior webpage to return to the prior send e-mail webpage 1100. If the user clicks on the send e-mail button 1206, the e-mail is generated by the system and sent to the associated lead. As indicated in FIG. 12, realtor contact information 1208 may be shown and accompany the e-mail content 1202. A photo of the realtor 1210 may also be included

Upon transmitting the e-mail, the system may then update the CRM tool so that the entries for the lead include the new dispositions selected for the e-mail and the accompanying notes and other relevant information. The user is then generally returned to the lead detail page, FIGS. 7 and 8, which then display the updated CRM information.

Generally ALD/auto lead delivery is activated automatically for the realtor. As soon as the first pre-payment is charged or an agreement or contract is created, the system preferably turns on the ALD service automatically. The ALD service may be turned on or off by any user with sufficient privileges, such as an admin user. Such a user may have the option of going to the ALD page to enter a cell phone number for the admin user. If no cell phone number is entered for the user, leads will generally be sent to the user's e-mail address. By providing auto lead delivery, the ALD service transmits new lead information and otherwise to the user in a manner generally chosen as being most convenient by the user. Admin users generally cannot turn off the ALD service when a user has an active contract in the system and the ALD page (in one embodiment, a .aspx page) should generally only be accessible by admin users having sufficient privileges.

The present system may use credit cards for financial transaction purposes. In allowing the user to update the credit card information, authorization is first verified before the new card is accepted for charges on the credit card. By navigating to the update billing information page, the user can enter new credit card information and submit it to the system for approval by clicking the submit button or the like. The system attempts to authorize the credit card for a nominal amount, such as one dollar, and if the credit card authority, such as VeriSign, approves a credit card, the system will update the credit card information for the user. However, if the credit card authority declines the charge, the system will generally not update the user's credit card information. When the authorization system declines the client's charge, a message may be returned to the user letting him know that the card cannot be validated and ask that the information be verified and possibly submitted again.

Credits may be issued online through a webpage by users having sufficient privilege. If such privileges are not attached to the user's account, the system will generally return them to the page from which they came should they try and access the issue credit page. Additionally, new admin users can be added through a similar secure procedure.

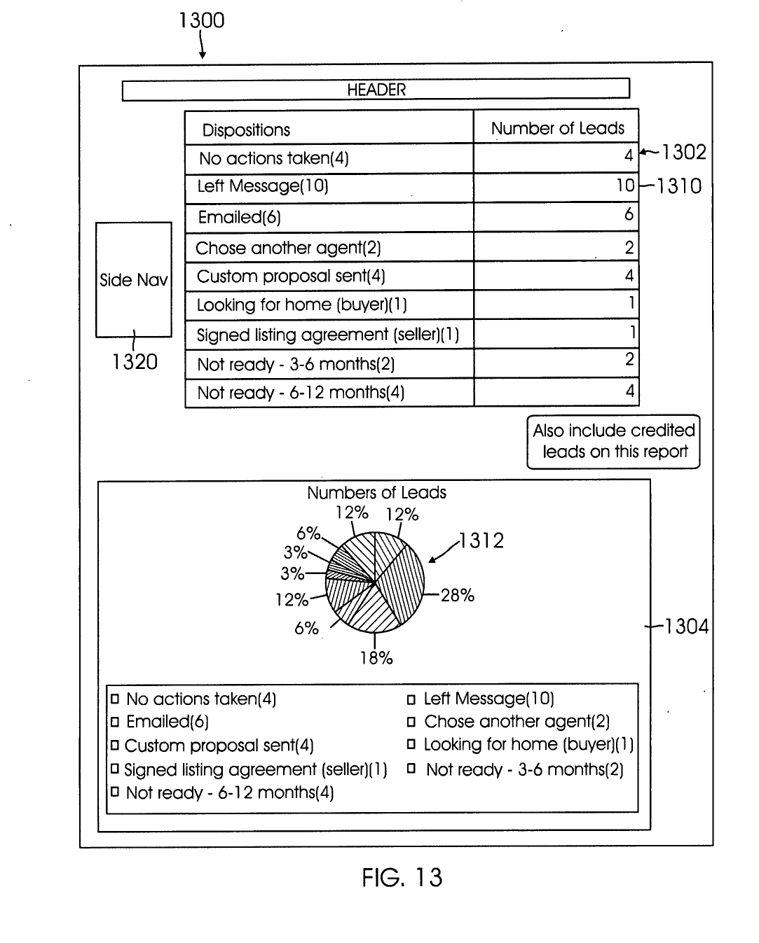

Reports on leads can be provided to the user via a webpage or similar as shown in FIG. 13. The lead reporting webpage 1300 may be generated by the system upon request by the user or otherwise. While the lead reporting webpages of FIGS. 7 and 8 show the last disposition of each lead, they do not provide feedback to the realtor or retention agent that the program is successful. Consequently, it helps the user to know what kind of success the system is providing him in order that he may better put it to his use.

The lead report page 1300 may provide may preferably provide a wrap up of all the leads purchased with their current disposition as well as information on credited leads. The lead reporting webpage may show a disposition table 1302 as well as a chart 1304 generally indicating the same information in a different format. As can be seen in the disposition table 1302, the “left message” row entry 1310 has 10 entries which is the largest number of entries for the leads listed in the disposition table 1302. This corresponds the largest part of the pie chart graphic 1312 and in accordance with the total number of leads, is equivalent to 28% of all leads. Consequently, over one quarter of the leads with which the user has been in contact have left a message.

Other features are present on the lead reporting webpage 1300 with regards to header information and the like. A side navigation bar 1320 may be present on this and other webpages of the present system to allow navigation between different webpages.

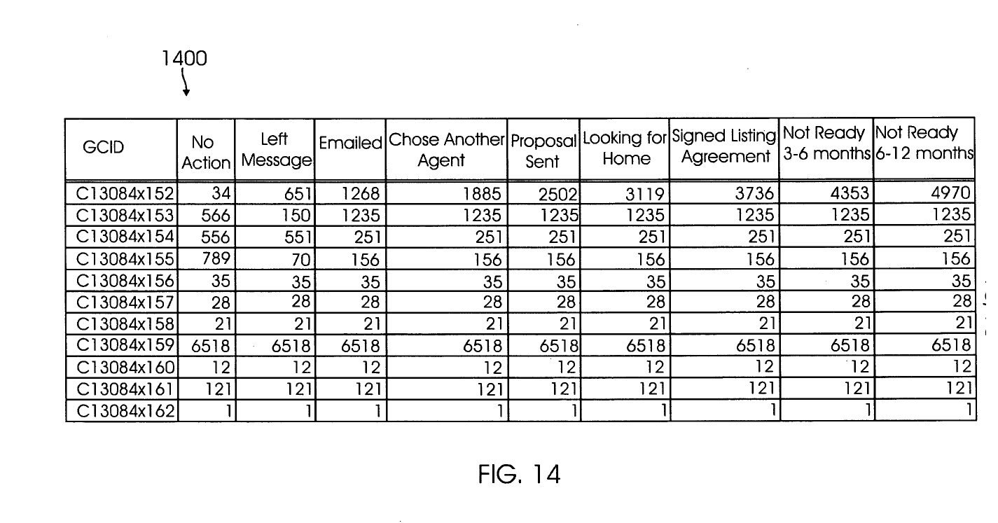

FIG. 14 shows a marketing report 1400 in tabular form. Close inspection of the marketing report 1400 generally indicates the information provided there and the report may act as a compilation of information for all users, specific users, specific groups of users, and/or similar sets of leads.

Other quantitative feedback information can be provided on an agent/realtor/user basis or otherwise. Relevant information generally includes an indication of what action was taken for each lead and information regarding the capitalization of the user/realtor on leads individually and as a group as a whole.

For those users who want to improve return on investment/ROI, automated suggestions can be sent by e-mail or otherwise the user.

Several advantages arise from implementation of the present system. Among these include the benefit of having more free time or more available time with which to pursue customer contact and development. Once such contact has been made, customer development becomes easier. The CRM system set forth herein reminds the user to further develop the new contacts and provides means by which retrospective evaluation can occur regarding customer/client contact and development.

These and other advantages, utilities, applications, and solutions provided by the present invention will be apparent from a review of the specification herein and accompanying drawings. The foregoing are some of but a few of the goals sought to be attained by the present invention and are set forth for the purposes of example only and not those of limitation.

While the present invention has been described with regards to particular embodiments, it is recognized that additional variations of the present invention may be devised without departing from the inventive concept.

What is claimed is:

1. A system for facilitating client relationship management, comprising:
at least one database resident on a server computer for storing lead data;
a client relationship management software module resident on said server computer for updating lead data;
an electronic mail update software module resident on said server computer configured to provide instructions and request feedback;
a return on investment software module resident on said server computer for reporting on value gained from using the system;
said client relationship management software module, said electronic mail update software module, and said return on investment software module all transmit data from said server computer over an Internet, intranet, and/or local network;
said server computer transmitting new lead data and lead contact updates to a user;
said requests for feedback provided by said electronic mail update software module, occurring at predefined intervals, and comprising messages selected from the group consisting of lead sent email, first email not clicked, second update email, additional update email, no action taken, what happened to the lead purchased, and reminder email;
said client relationship management software module updating lead data based upon predetermined email responses selected from the group consisting of first email not clicked, left message, emailed, custom proposal sent, no action taken, looking for homes, under contract, not ready, and closed transaction; and
said report generated by said return on investment software module comprising a summary of all responses emailed by the user, leads purchased, current dispositions, success metrics, and quantitative feedback.

2. A system for facilitating client relationship management as set forth in claim 1, further comprising:
at least one port configured to exchange data with said server computer by an electronic mail communication application, said port selected from the group consisting of a laptop, internet terminal, computer, mobile device, PDA, or smart phone.

3. A computer readable medium containing instruction sets for a computer system, comprising:
a computer implemented client relationship management software module resident on a server computer for updating lead data;
a computer implemented electronic mail update software module resident on a server computer configured to provide instructions and request feedback;
a computer implemented return on investment software module resident on a server computer for reporting on value gained from using the system;
said client relationship management software module, said electronic mail update software module, and said return on investment software module all transmit data from said server computer over an Internet, intranet, and/or local network;
said requests for feedback provided by said electronic mail update software module occurring at predefined intervals and comprising messages selected from the group consisting of lead sent email, first email not clicked, second update email, additional update email, no action taken, what happened to the lead purchased, and reminder email;
said client relationship management software module updating lead data based upon predetermined email responses selected from the group consisting of first email not clicked, left message, emailed, custom proposal sent, no action taken, looking for homes, under contract, not ready, and closed transaction; and
said report generated by said return on investment software module comprising a summary of all responses emailed by the user, leads purchased, current dispositions, success metrics, and quantitative feedback.

4. A process for facilitating client relationship management, comprising:
collecting lead data in at least one database resident on a server computer;
executing a client relationship management software module resident on said server computer to update lead data;
executing an electronic mail update software module resident on said server computer to provide instructions and request feedback;
executing a return on investment software module resident on said server computer to report value gained from using the system;
said client relationship management software module, said electronic mail update software module, and said return on investment software module all transmit data from said server computer over an Internet, intranet, and/or local network;
said server computer transmitting new lead data and lead contact updates to a user.
said requests for feedback provided by said electronic mail update software module, occurring at predefined intervals, and comprising messages selected from the group consisting of lead sent email, first email not clicked, second update email, additional update email, no action taken, what happened to the lead purchased, and reminder email;
said client relationship management software module updating lead data based upon predetermined email responses selected from the group consisting of first email not clicked, left message, emailed, custom proposal sent, no action taken, looking for homes, under contract, not ready, and closed transaction; and
said report generated by said return on investment software module comprising a summary of all responses emailed by the user, leads purchased, current dispositions, success metrics, and quantitative feedback.

5. A process for facilitating client relationship management as set forth in claim 4, further comprising:
transmitting new lead data to at least one port configured to exchange data with said server computer by an electronic mail communication application, said port selected from the group consisting of a laptop, internet terminal, compute, mobile device, PDA, or smart phone.

6. A system for facilitating client relationship management, comprising:
(a) at least one database resident on a server computer for storing lead data;
(b) a client relationship management software module resident on said server computer for updating lead data;
(c) an electronic mail update software module resident on said server computer configured to provide instructions and request feedback;
(d) a return on investment software module resident on said server computer for reporting on value gained from using the system; and
(e) at least one port configured to exchange data with said server computer by a communication application.

7. The system of claim 6, wherein said communication application is electronic mail.

8. The system of claim 6, wherein said client relationship management software module transmits data from said server computer over an Internet, intranet, or local network.

9. The system of claim 6, wherein said electronic mail update software module transmits data from said server computer over an Internet, intranet, or local network.

10. The system of claim 6, wherein said return on investment software module transmits data from said server computer over an Internet, intranet, or local network.

11. The system of claim 6, wherein said port is selected from the group consisting of a laptop, internet terminal, computer, mobile device, PDA, or smart phone.

12. The system of claim 6, wherein said server computer transmits new lead data and lead contact updates to a user.

13. The system of claim 6, wherein said requests for feedback provided by said electronic mail update software module comprise of messages selected from the group consisting of lead sent email, first email not clicked, second update email, additional update email, no action taken, what happened to the lead purchased, and reminder email.

14. The system of claim 6, wherein said requests for feedback provided by said electronic mail update software module occur at predefined intervals.

15. The system of claim 6, wherein said client relationship management software module updates lead data based upon predetermined email responses, selected from the group consisting of first email not clicked, left message, emailed, custom proposal sent, no action taken, looking for homes, under contract, not ready, and closed transaction.

16. The system of claim 6, wherein said report generated by said return on investment software module comprises a summary of all responses emailed by the user, leads purchased, current dispositions, success metrics, and quantitative feedback.

17. A computer readable medium containing instruction sets for a computer system, comprising:
(a) a computer implemented client relationship management software module resident on a server computer for updating lead data;
(b) a computer implemented electronic mail update software module resident on said server computer configured to provide instructions and request feedback; and
(c) a computer implemented return on investment software module resident on said server computer for reporting on value gained from using the system.

18. The computer readable medium of claim 17, wherein said client relationship management software module transmits data from said server computer over an Internet, intranet, or local network.

19. The computer readable medium of claim 17, wherein said electronic mail update software module transmits data from said server computer over an Internet, intranet, or local network.

20. The computer readable medium of claim 17, wherein said return on investment software module transmits data from said server computer over an Internet, intranet, or local network.

21. The computer readable medium of claim 17, wherein said requests for feedback provided by said electronic mail update software module comprise of messages selected from the group consisting of lead sent email, first email not clicked, second update email, additional update email, no action taken, what happened to the lead purchased, and reminder email.

22. The computer readable medium of claim 17, wherein said requests for feedback provided by said electronic mail update software module occur at predefined intervals.

23. The computer readable medium of claim 17, wherein said client relationship management software module updates lead data based upon predetermined email responses, selected from the group consisting of first email not clicked, left message, emailed, custom proposal sent, no action taken, looking for homes, under contract, not ready, and closed transaction.

24. The computer readable medium of claim 17, wherein said report generated by said return on investment software module comprises a summary of all responses emailed by the user, leads purchased, current dispositions, success metrics, and quantitative feedback.

25. A process for facilitating client relationship management, comprising:
(a) collecting lead data in at least one database resident on a server computer;
(b) transmitting new lead data to at least one port configured to exchange data with said server computer by a communication application;
(c) executing a client relationship management software module resident on said server computer to update lead data;
(d) executing an electronic mail update software module resident on said server computer to provide instructions and request feedback; and
(e) executing a return on investment software module resident on said server computer to report value gained from using the system.

26. The process of claim 25, wherein said communication application is electronic mail.

27. The process of claim 25, wherein said client relationship management software module transmits data from said server computer over an Internet, intranet, or local network.

28. The process of claim 25, wherein said electronic mail update software module transmits data from said server computer over an Internet, intranet, or local network.

29. The process of claim 25, wherein said return on investment software module transmits data from said server computer over an Internet, intranet, or local network.

30. The process of claim 25, wherein said port is selected from the group consisting of a laptop, internet terminal, computer, mobile device, PDA, or smart phone.

31. The process of claim 25, wherein said server computer transmits new lead data and lead contact updates to a user.

32. The process of claim 25, wherein said requests for feedback provided by said electronic mail update software module comprise of messages selected from the group consisting of lead sent email, first email not clicked, second update email, additional update email, no action taken, what happened to the lead purchased, and reminder email.

33. The process of claim 25, wherein said requests for feedback provided by said electronic: mail update software module occur at predefined intervals.

34. The process of claim 25, wherein said client relationship management software module updates lead data based upon predetermined email responses, selected from the group consisting of first email not clicked, left message, emailed, custom proposal sent, no action taken, looking for homes, under contract, not ready, and closed transaction.

35. The process of claim 25, wherein said report generated by said return on investment software module comprises a summary of all responses emailed by the user, leads purchased, current dispositions, success metrics, and quantitative feedback.
